(19) United States
(12) Patent Application Publication
(10) Pub. No.: US 2023/0166452 A1
(43) Pub. Date: Jun. 1, 2023

(54) SELF-REPAIRING 3D PRINTER

(71) Applicant: International Business Machines Corporation, Armonk, NY (US)

(72) Inventors: Clement Decrop, Arlington, VA (US); Tushar Agrawal, West Fargo, ND (US); Jeremy R. Fox, Georgetown, TX (US); Sarbajit K. Rakshit, Kolkata (IN)

(21) Appl. No.: 17/456,668

(22) Filed: Nov. 29, 2021

(51) Int. Cl. B29C 64/386; G05B 19/418; B33Y 50/00

(52) U.S. Cl. CPC B29C 64/386; B33Y 50/00; G05B 19/41865; B33Y 10/00; G05B 2219/32252; G05B 2219/33062; G05B 2219/49023

(57) ABSTRACT

Provided are a method, computer program product, and system for repairing a defective component of a 3D printer. The method comprises identifying a defective component in a 3D printer. The method further comprises determining one or more repair actions for the defective component. The method further comprises determining an order of priority for a set of print jobs for the 3D printer and the one or more repair actions. The method further comprises performing the set of print jobs and the one or more repair actions in accordance with the determined order of priority.

### BACKGROUND

The present disclosure relates generally to the field of additive manufacturing, and more particularly to self-repairing 3D printers.

Additive manufacturing, also referred to as 3D printing, is the construction of three-dimensional objects from a digital model using a variety of processes in which material is deposited, joined, or solidified under computer control. Traditionally, layers of material (e.g., plastics, metals, etc.) are deposited one by one until the desired three-dimensional object has been completely built up.

### SUMMARY

Embodiments of the present disclosure include a method, computer program product, and system for repairing a defective component of a 3D printer. The method comprises identifying a defective component in a 3D printer. The method further comprises determining one or more repair actions for the defective component. The method further comprises determining an order of priority for a set of print jobs for the 3D printer and the one or more repair actions. The method further comprises performing the set of print jobs and the one or more repair actions in accordance with the determined order of priority.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a block diagram of an example computing environment in which illustrative embodiments of the present disclosure may be implemented.

FIG. 2A illustrates a flowchart of an example method for identifying and repairing a defect in a 3D printer, in accordance with embodiments of the present disclosure.

FIG. 2B illustrates a flowchart of an example method for determining repair actions for repairing a defect in a 3D printer, in accordance with embodiments of the present disclosure.

FIG. 3 illustrates an example flow diagram for repairing a defective component in a 3D printer, in accordance with embodiments of the present disclosure.

FIGS. 4A-4B illustrates an example 3D printer during performance of a self-repair operation, in accordance with embodiments of the present disclosure.

FIG. 5 illustrates a second example 3D printer during performance of a self-repair operation, in accordance with embodiments of the present disclosure.

FIG. 6 illustrates an example 3D printer performing an assisted repair operation to repair a second 3D printer, in accordance with embodiments of the present disclosure.

FIG. 7 illustrates a high-level block diagram of an example computer system that may be used in implementing one or more of the methods, tools, and modules, and any related functions, described herein, in accordance with embodiments of the present disclosure.

FIG. 8 depicts a cloud computing environment, in accordance with embodiments of the present disclosure.

FIG. 9 depicts abstraction model layers, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the invention.

### DETAILED DESCRIPTION

Aspects of the present disclosure relate generally to the field of additive manufacturing, and in particular to self-repairing 3D printers. While the present disclosure is not necessarily limited to such applications, various aspects of the disclosure may be appreciated through a discussion of various examples using this context.

As additive manufacturing becomes more advanced, with additional material types being supported (e.g., metal), additive manufacturing is being increasingly relied upon to create objects ranging from the mass production of small toys all the way up to production of complex parts for space ships. This has led to the creation of so-called 3D print farms, where many 3D printers are run simultaneously and as continuously as possible, often with little to no human intervention, putting additional strain on the 3D printers.

If a component in the 3D printer begins to break, it can have a wide range of effects. For example, a defective component in a 3D printer may cause the object being printed to be defective itself due to inaccurate printing and/or layering of the materials. While small defects in the printed object may be acceptable in some cases, in other situations (e.g., when printing components for a space ship), such defects can be dangerous if allowed to continue. As a result, some objects that are being printed may have to be discarded as a result of the defective 3D printing component, often resulting in a loss of many hours’ worth of printing. Additionally, any downtime in a 3D printer due to a defective component, such as one caused by the near 24/7 operation of the 3D printer, results in project delays or lost profits from reduced sales.

Embodiments of the present disclosure address these and other issues with current 3D printing systems by utilizing self-repairing 3D printers that can detects defects in the 3D printer, proactively and dynamically reprioritize the print jobs being performed by the 3D printer, and perform a self-repair or have a second 3D printer perform an assisted repair. This can reduce the total amount of downtime for the 3D printer and enable a 3D printer to continue printing, where possible, using adjusted print settings.

Embodiments include identifying a plurality of parts of the 3D printer. The parts may be identified using, for example, camera detection, computer-aided design (CAD) files, and/or a parts list for the printer. Operational properties of the plurality of parts are also identified. The operational properties describe the type of operations performed by the part(s). For example, the operation properties may include whether the part is static or dynamic, a type of motion for moving parts, such as rotational or translational, and an average speed of the moving parts. Accordingly, a bearing may be identified as a dynamic, rotational component with an operational range of 1000 - 2500 RPMs, and an average speed of 1500 RPMs.

Operation of the 3D printer is then monitored using one or more sensors. The sensors are configured to monitor the 3D printer and/or the object being printed to detect a defect in a component. The sensors can include, for example, cameras, thermal sensors to detect hot spots, vibrational sensors to detect unexpected vibration, which could indicate that a rotational component has become defective, rotational sensors to detect the speed of rotation of a component, and/or any other suitable sensors. Using the data from the sensors, a defect in a particular part is detected. Detecting the defect may include, for example, comparing the sensor data to historical performance data for the 3D printer and/or similar 3D printers. If the sensor data is outside of a normal range (e.g., as defined by one or more thresholds and the historical performance data), the 3D printer may determine that a component associated with the sensor data is defective.

In some embodiments, detecting that there is a defect in a component may include performing image analysis on image data collected from the camera. The image analysis may include comparing the image of a component to, for example, a CAD file for the component. The image analysis may additionally, or alternatively, include performing object detection using machine vision algorithms. For example, the image analysis may be used to detect a crack in a component on the 3D printer.

In some embodiments, the object being printed is analyzed to detect a defect in a component. This may be particularly beneficial when the defect is internal to the 3D printer and not otherwise visible. For example, image analysis on the object being printed may show that the layers of material are not being uniformly deposited. This may indicate that there is a defect in the extruder, the heating coils, and/or the nozzle that is causing less than the expected amount of material to be extruded.

After identifying a defective component, the 3D printer may predict an estimated time to failure for the defective component. The estimated time to failure may depend on the type of defective component, the extent of damage to the defective component, and the stresses expected to be exerted on the defective component by continued printing. This may include analysis of the pending print jobs for the printer to predict future stresses. The time to failure may have an associated confidence interval, and it may be an amount of time, a number of print jobs, an amount of material printed, or any other suitable metric for assessing failure time.

In some embodiments, the 3D printer may determine that the defective component has already effectively failed. A component is considered to have failed when the 3D printer is no longer able to perform its printing jobs. This may be because the 3D printer is unable to print at all or because the reliability of the printed object will not be high enough. For example, a defective print nozzle may still be able to deposit material, but the amount of material that it is depositing may be too little or too inaccurate to meet quality requirements for the print job.

The 3D printer may also determine what repair options are available. This may be based on the type and extent of damage to the defective component, the importance of the defective component, whether the 3D printer is still operational, whether replacement components are available or can be 3D printed, whether the 3D printer can directly repair (e.g., print directly on) the defective component, and whether assisted repair using one or more other 3D printers is available. If multiple repair operations are available, the 3D printer may select the repair option that maximizes the total amount of printing jobs that are completed by the 3D printer and, in the case of assisted repair, any assisting 3D printers. In other embodiments, the 3D printer may be configured to prioritize the fastest repair option.

The 3D printer may reprioritize one or more printing jobs and the determined repair activities. The re-prioritization may be based on user-preference. For example, the 3D printer may be configured to finish its current print job in response to detecting a defect in a component and then immediately begin repair actions. In other embodiments, the 3D printer may prioritize the jobs and repair actions based on, for example, an estimated time required for self-repair or assisted repair, an estimated time to complete the printing jobs, performance degradation caused by the defect, etc. Re-prioritizing the print jobs may include moving one or more print jobs that are still performable to the top of the list, and either moving the print jobs that cannot be performed to the end of the list or sending them to another printer.

In some embodiments, the 3D printer may also modify its operational parameters. This may be done to extend the life of the defective component and/or to ensure that the quality of the printed objects does not drop below an acceptable level. The operational parameters may also be modified to ensure that the 3D printer will be able to successfully repair the defective component before failure of the defective component. Modifying the operational parameters may include, for example, decreasing the print speed. This may result in lower RPMs of bearing and/or reduced stress on other components, thereby extending the life of the defective component.

The 3D printer may then perform a self-repair operation, wherein the self-repair operation is tailored to the detected defect. In some embodiments, the self-repair operation may include printing a replacement component. The replacement component may then be installed on the 3D printer by the 3D printer itself (if possible), by another 3D printer or machine, or by a human. In other embodiments, the self-repair operation may include printing directly on the defective component. For example, the 3D printer may fill a crack in a defective component by printing new material directly into the crack. As discussed above, performing the self-repair operation may include stopping or modifying other operations of the 3D printer. For example, a defect to a static part may not require stopping operation of the 3D printer since the material deposited in the crack in the static part is likely going to be able to solidify without much problem. On the other hand, a defect to a dynamic part may require stopping the printer or reducing its operational speed until the material added to the defective part solidifies to prevent the repair material from being flung out of the crack.

In some circumstances, the 3D printer may not be able to self-repair. In these circumstances, the 3D printer may request an assisted repair operation. As used herein, an “assisted repair operation” or “assisted repair” is when a second 3D printer (or multiple other 3D printers) repairs the broken 3D printer (e.g., directly by printing on the defect or indirectly be printing a replacement component). If neither self-repair nor assisted repair is available, the 3D printer may raise an alert to an operator (e.g., a human) to schedule a repair. The 3D printer may also analyze an inventory to determine whether there is a replacement component in stock and, if not, order a replacement component automatically. This may reduce the downtime of the 3D printer.

In some embodiments, If self-repairing is required, then the 3D printer is configured to repair the machine parts in multiple phases. Each phase may include depositing a set of material, preparing the 3D printer for a deposition step, etc. First, the 3D printer reconfigured itself in a self-repairing mode. This may include reducing the rotational speed of different machine parts, stopping at a particular position where repairing is required, etc. Then the 3D printer begins the self-repair process.

In some embodiments, while performing self-repairing in different phases, the 3D printer creates appropriate pressure for laying the material in layers, so that when the machine is stopped, then the pressure will be forcing the material to correct the defect. In this case, the pressure can be applied with a bypass mechanism, like air stored in a chamber, etc. The 3D printing will gradually be repairing itself in multiple deposition phases, starting and stopping in every phase to allow solidification of the repair material layers. Accordingly, during self-correcting activity, the 3D printer will be predicting the solidification of rectified portion, and accordingly based on solidification time, the 3D printer will be resuming self-repairing (e.g., depositing another layer).

It is to be understood that the aforementioned advantages are example advantages and should not be construed as limiting. Embodiments of the present disclosure can contain all, some, or none of the aforementioned advantages while remaining within the spirit and scope of the present disclosure.

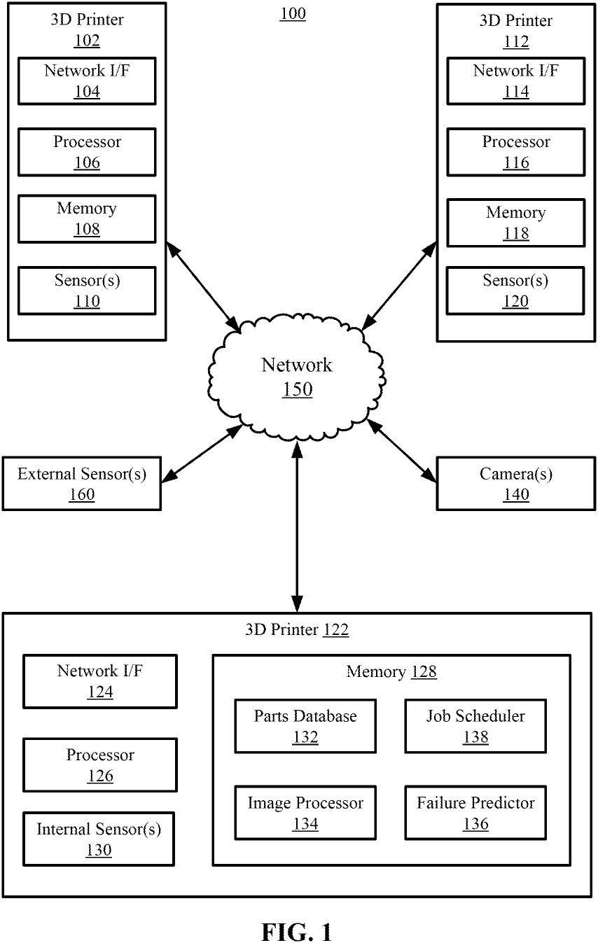

Turning now to the figures, FIG. 1 illustrates a block diagram of an example computing environment 100 in which illustrative embodiments of the present disclosure may be implemented. In some embodiments, the computing environment 100 may include three 3D printers, 102, 112, 122.

Consistent with various embodiments, the 3D printers, 102, 112, 122 may be machines configured to perform additive manufacturing to create objects. The 3D printers, 102, 112, 122 may include an on-board computer system for controlling the 3D printing and for performing the operations discussed herein. For example, the on-board computer systems for the 3D printers, 102, 112, 122 may include one or more processors 106, 116, and 126 and one or more memories 108, 118, and 128, respectively. The 3D printers, 102, 112, 122 may be configured to communicate with each other through an internal or external network interface 104, 114, and 124. The network interfaces 104, 114, and 124 may be, for example, modems or network interface cards. The 3D printers, 102, 112, 122 may be equipped with a display or monitor. Additionally, the 3D printers, 102, 112, 122 may include optional input devices (e.g., a keyboard, mouse, scanner, or other input device), and/or any commercially available or custom software (e.g., communications software, server software, image analysis software, filter modules for filtering content based upon predefined parameters, etc.).

In some embodiments, the 3D printers, 102, 112, 122 may be configured to communicate with each other in an ad-hoc fashion. Essentially, the 3D printers, 102, 112, 122 may create a printer swarm, in which the 3D printers, 102, 112, 122 coordinate with each other to perform the repair operations discussed herein. In other embodiments, the 3D printers, 102, 112, 122 may communicate with servers, desktops, laptops, or hand-held devices, such as smart phones or tablets. For example, in some embodiments, the 3D printer 122 may instead be replaced by a management computer that is responsible for assigning print jobs to the 3D printers 102, 112 and detecting defects in the 3D printers 102, 112. The management computer may also be responsible for determining how to respond to the defects and for issuing repair actions (self-repair or assisted repair actions) to the 3D printers 102, 112.

The 3D printers, 102, 112, 122 may be distant from each other and communicate over a network 150. In some embodiments, one of the 3D printers 122 may be a central hub from which the other 3D printers 102, 112 can establish a communication connection, such as in a client-server networking model. This may be particularly advantageous in embodiments where one of the 3D printers 122 acts as a management device for the other 3D printers 102, 112. Alternatively, the 3D printers, 102, 112, 122 may be configured in any other suitable networking relationship (e.g., in a peer-to-peer configuration or using any other network topology).

In some embodiments, the network 150 can be implemented using any number of any suitable communications media. For example, the network 150 may be a wide area network (WAN), a local area network (LAN), an internet, or an intranet. In certain embodiments, the 3D printers, 102, 112, 122 may be local to each other, and communicate via any appropriate local communication medium. For example, the 3D printers, 102, 112, 122 may communicate using a local area network (LAN), one or more hardwire connections, a wireless link or router, or an intranet. In some embodiments, the 3D printers, 102, 112, 122 may be communicatively coupled using a combination of one or more networks and/or one or more local connections. For example, the first 3D printer 102 may be hardwired to the third 3D printer 122 (e.g., connected with an Ethernet cable) while the second 3D printer 112 may communicate with the third 3D printer 112 using the network 150 (e.g., over the Internet).

In some embodiments, the network 150 can be implemented within a cloud computing environment, or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 150.

In some embodiments, the 3D printers, 102, 112, 122 may form a 3D print farm and be used to create numerous components. For example, the 3D printers, 102, 112, 122 may include a user interface (UI) and one or more applications (not shown) that are used to add print jobs to the 3D printers, 102, 112, 122 using, for example, CAD files of the object to be printed. The 3D printers, 102, 112, 122 may accordingly include software that converts the CAD files into print instructions that enable printing of the object described in the CAD files. In some embodiments, remote systems (not shown) may transmit the print jobs to the 3D printers, 102, 112, 122, or the 3D printers, 102, 112, 122 may access print jobs from a database or print repository using data access applications on the 3D printers, 102, 112, 122. The data access applications may be in the form of a web browser or any other suitable software module, and the UI may be any type of interface (e.g., command line prompts, menu screens, graphical user interfaces). The UI may allow a user to interact with the 3D printers, 102, 112, 122 to schedule print jobs.

In some embodiments, the 3D printers, 102, 112, 122 may include internal sensors 110, 120, 130 for monitoring performance of the 3D printers, 102, 112, 122. The internal sensors 110, 120, 130 may include cameras and/or other sensors (e.g., vibration sensors), as discussed herein. Additionally, the 3D printers, 102, 112, 122 may be communicatively coupled to external sensors 160 and cameras 140. The data from the internal sensors 110, 120, 130, the external sensors 160, and the cameras 140 may be analyzed to detect defects in one of the 3D printers, 102, 112, 122, as discussed herein.

In some embodiments, the 3D printer 122 may include a parts database 132, an image processor 134, a failure predictor 136, and a job scheduler 138 stored in the memory 128. It is to be understood that while only one 3D printer 122 is shown as having these components, in some embodiments each 3D printer 102, 112, 122 will have these components. In some embodiments, the other 3D printers 102, 112 instead transmit their data to the third 3D printer 122, which is responsible for analyzing the information for all (or a subset) of the 3D printers in, for example, a 3D print farm.

The parts database 132 may include a list of components found in the 3D printer. The parts database 132 may further include operational parameters for the individual components, as well as one or more 2D or 3D models of the components. The 3D printer 122 may utilize the parts database 132 to determine what a normal (i.e., not defective) component is supposed to look like.

The image processor 134 may be a software module configured to analyze image data received from a camera (e.g., an internal camera and/or external camera 140) to identify the component(s) in the image data and determine whether the component(s) in the image data are defective. The image processor 134 may include submodules for identifying specific types of defects, such as cracks, in the components. The image processor 134 may also be configured to retrieve data from the parts database 132 for the identification of a component and the detection of a possible defect in the component.

For example, the image processor 134 may collect an image of a component using the camera 140. This may be done, for example, in response to data from an internal sensor 130, such as vibration data received from a vibration sensor, indicating that there may be a defect in a region of the 3D printer 122. The image processor 134 may then compare the component(s) in the image to components found in the parts database 132 to detect which components are in the image. The image processor 134 may further compare the components in the image and the parts database 132 to determine whether a defect exists in a component and, if so, what type of defect. For example, the image processor 134 may detect a crack in the image using a crack detection submodule of the image processor 134.

The data from the image processor 134, the internal sensor(s) 130, the external sensor(s) 160, and the camera(s) 140 may be retrieved by the failure predictor 136. The failure predictor 136 may then determine the extent of the damage to the component and an estimated time to failure for the component. The failure predictor 136 may make this determination using historical performance data (not shown), which describes performance of the 3D printer 122 (or other 3D printers) with a similar defect. In some embodiments, the failure predictor 136 may additionally determine modifications to operational parameters that enable continued printing operations to be performed during repair and/or that would extend the life of the defective component (e.g., long enough to repair the 3D printer). For example, the failure predictor 136 may determine that a defective bearing should be run at a reduced speed in order to permit continued, albeit slower, printing without causing premature failure of the bearing (e.g., before it can be replaced).

The job scheduler 138 is configured to analyze the pending jobs and the repair actions to determine, using the information obtained from the image processor 134 and/or the failure predictor 136, how to reprioritize the pending jobs. Reprioritization may be based on, for example, the time to failure of the defective component, the importance of the pending jobs, the type of repair action(s) to be performed, and user-defined preferences.

In some embodiments, the image processor 134, the failure predictor 136, and/or the job scheduler 138 may include artificial intelligence and/or machine learning models or algorithms trained to perform the functions of these components. For example, the image processor 134 may include artificial intelligence algorithms or models that are trained to identify defects of a component. Likewise, the failure predictor 136 may include artificial intelligence algorithms or models that are trained to predict when a defective component will fail or what operational properties should be adjusted to extend the life of the defective component. Finally, the job scheduler 138 may include artificial intelligence algorithms or models that are trained to reprioritize jobs and repair actions based on user preference.

In some embodiments, the machine learning component may be configured as a machine learning engine, module, or system such as IBM Watson®. The machine learning component can utilize machine learning and/or deep learning, where algorithms or models can be generated by performing supervised, unsupervised, or semi-supervised training on historical performance data for defective components. Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naive Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBDT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naive Bayes, multinomial naive Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

While FIG. 1 illustrates a computing environment 100 with three 3D printers, 102, 112, 122, suitable computing environments for implementing embodiments of this disclosure may include any number of 3D printers. The various models, modules, systems, and components illustrated in FIG. 1 may exist, if at all, across a plurality of 3D printers. In other embodiments, the computing environment 100 includes a management node or system. The management system may be a computer system that is configured to monitor the 3D printers, 102, 112, 122. Accordingly, the management system may include the components discussed as being part of the 3D printer 122.

It is noted that FIG. 1 is intended to depict the representative major components of an exemplary computing environment 100. In some embodiments, however, individual components may have greater or lesser complexity than as represented in FIG. 1, components other than or in addition to those shown in FIG. 1 may be present, and the number, type, and configuration of such components may vary.

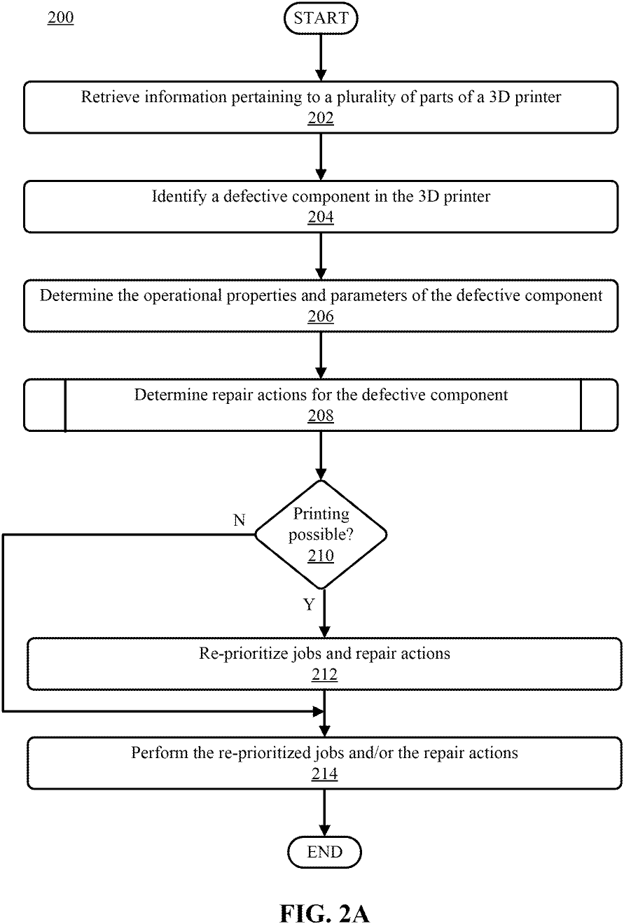

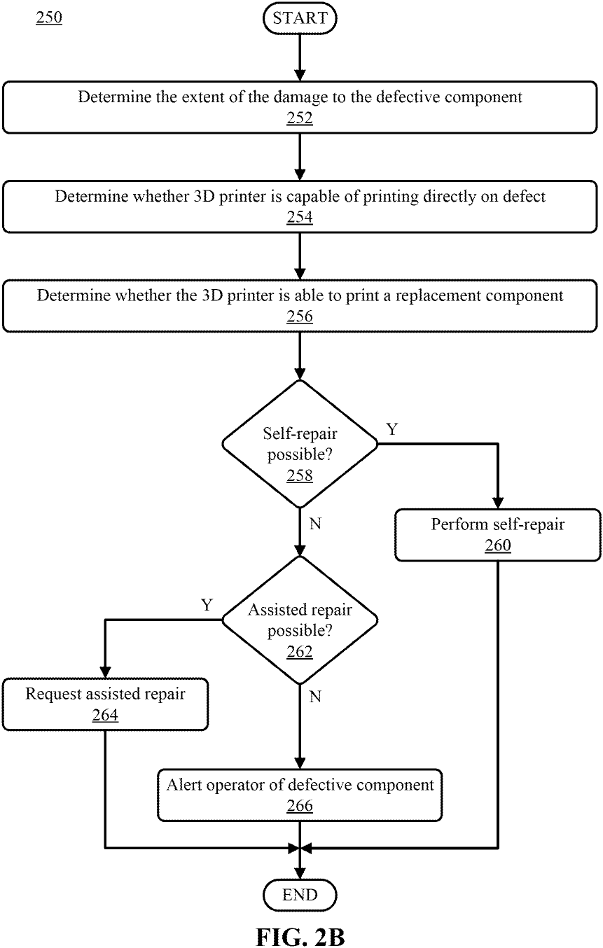

Referring now to FIG. 2A, illustrated is a flowchart of an example method 200 for identifying and repairing a defect in a 3D printer, in accordance with embodiments of the present disclosure. The method 200 may be performed by hardware, firmware, software executing on a processor, or any combination thereof. For example, the method 200 may be performed by a processor (e.g., in a 3D printer 122 or management system). The method 200 may contain multiple subprocesses. For example, operation 208 may be broken down into multiple suboperations, such as those discussed with respect to the method 250 shown in FIG. 2B.

The method 200 may begin at operation 202, where the processor retrieves information pertaining to a plurality of parts of a 3D printer. The information may be retrieved from, for example, a CAD design of the 3D printer, a parts list for the 3D printer, and/or image analysis of the 3D printer. The information may include, for example, a list of components of the 3D printer, information pertaining to how the components are arranged, operational parameters and/or properties of the components, materials that the components are made out of, known common defects that the components develop, and the like.

At operation 204, the processor identifies a defective component in the 3D printer. The processor may detect the defect using, for example, image analysis of the defective component. The image analysis may involve, for example, convolutional neural network image detection algorithms to identify a crack in the defective component. In some embodiments, historical performance data and/or internet of things (IoT) sensors may be used to detect the defective component. For example, the processor may take a picture of the 3D printer using a thermal sensor/camera. The processor may then identify a “hot spot” in the image. By comparing the hot spot to historical performance data for the 3D printer, which may include one or more thermal images of the 3D printer during normal operation, the processor may determine that the hot spot shows a component that is unusually hot, potentially indicating a defect in a dynamic (i.e., moving) component.

As discussed herein, the sensor data may be analyzed by the processor to identify potential defects in the 3D printer. For example, vibration sensors on the 3D printer may be analyzed to determine that there is a larger than normal amount of vibration in an area of the 3D printer. If the processor is unable to determine which part is defective based solely on the vibration data, the processor may combine the vibration data with data from other sensors (e.g., imaging data, thermal data, rotational data from rotational sensors, etc.) to narrow down the defect to a particular component.

At operation 206, the processor determines the operational properties and parameters of the defective component. As discussed herein, the operation properties and parameters may include information such as whether the defective component is a static (i.e., unmoving) component or a dynamic component, whether the component is load bearing, whether the component impacts the quality of the printing, whether the 3D printer can operate with the component being defective, etc. The parameters may include, for example, specific values for the defective component. For example, a parameter for a rotational component may be its range in rotational velocity, its maximum rotational velocity, its average rotational velocity, etc. Likewise, a parameter for a static component may be, for example, and amount of force or load exerted on the component during normal operation.

At operation 208, the processor determines repair actions for the defective component. The repair actions may be grouped into three categories: self-repair, assisted repair, no repair. Self-repair includes operations where the 3D printer is able to repair the defective component on its own, either by directly repairing the defective component or by printing a replacement component. Assisted repair includes operations where the 3D printer requests that a second 3D printer repair the defective component, either by directly repairing the defective component or by printing a replacement component. No repair means that the 3D printer is unable to repair the component, either itself or using another 3D printer. In these cases, the 3D printer alerts an operator that a repair is needed, such as by raising an alert.

In some embodiments, the processor may prioritize whichever repair option is the quickest at operation 208. For example, the processor may determine that a replacement component is “on-hand” using inventory information. In these embodiments, the processor may determine that the quickest repair operation is to have a human (or robot) replace the component using the replacement component. In some embodiments, the processor may prioritize self-repair over assisted repair, whenever possible. Since assisted repair may require that both the 3D printer and a second 3D printer stop their current tasks, it may effectively take up two machines. As such, the processor may determine that self-repair has less overall down time for the 3D printer, when considered collectively, than an assisted repair operation. The method 250 shown in FIG. 2B is an example method where self-repair is prioritized over assisted repair.

At decision block 210, the processor determines if it is possible for the 3D printer to continue printing prior to the repair being performed. Determination of whether printing can continue may include consideration of modifications to the operational properties of the 3D printer. For example, the processor may determine that the 3D printer is not able to continue printing at full speed, but that reduction to 60% speed would allow the repair operation to be performed while the 3D printer is still awaiting repair.

If the processor determines that printing can continue (Yes at decision block 210), the processor re-prioritizes the print jobs and the repair actions. Re-prioritization of the jobs and repair actions may be done to ensure that the 3D printer is repaired prior to failure of the defective component. Accordingly, the jobs may be re-prioritized such that less stressing jobs (i.e., those that put fewer stresses on the defective component) are performed first. Likewise, re-prioritizing the jobs may include determining where to schedule the repair actions. For example, if the repair action include printing a replacement component, the jobs may be re-prioritized such that only the essential print jobs that are very time sensitive are performed before the repair actions.

Likewise, re-prioritizing the jobs may include minimizing the amount of motion of the defective product during an assisted repair operation. For example, the processor may determine that the repair operation is going to be having a second 3D printer mend the defect by printing directly on the defect to fill it in. The processor may coordinate with the second 3D printer to determine when it will be able to repair the first 3D printer. The processor may then schedule jobs for the first 3D printer during that time period, where the scheduled jobs are ones that require minimal or no movement of the defective component. That way, the defective component does not throw the repair material out of the defect prior to the material solidifying.

At operation 214, the processor executes or performs the re-prioritized jobs and/or repair actions, and the method 200 ends.

Referring now to FIG. 2B, illustrated is a flowchart of an example method 250 for determining repair actions for repairing a defect in a 3D printer, in accordance with embodiments of the present disclosure. The method 250 may be performed by hardware, firmware, software executing on a processor, or any combination thereof. For example, the method 250 may be performed by a processor (e.g., in a 3D printer 122). The method 250 may begin at operation 252, where the processor determines the extent of the damage to the defective component.

In some embodiments, the processor may determine the extent of the damage by analyzing the sensor data from a plurality of sensors and cameras. The sensor data may be compared to historical data for the 3D printer to determine an amount of variance from the normal operation in order to determine the amount of damage. For example, vibration data may be compared to historic vibration data using a plurality of thresholds. If the vibration data exceeds one threshold, but not the second or third thresholds, the damage may be considered minimal. Likewise, exceeding the first and second thresholds, but not the third, may be classified as moderate damage, and exceeding all three thresholds may results in a classification of significate damage.

Likewise, analysis of image data may determine the severity of a crack in the defective component. The length and depth of the crack may be correlated to an amount or extent of damage. Likewise, a determination of whether the crack has propagated all of the way through the component or not may be considered.

At operation 254, the processor determines whether the 3D printer is capable of printing directly on the defect. In some embodiments, the processor considers the range of motion of the printing nozzle, the location of the defect, the type of defect, the type of defective component, and whether the defect impairs the range of motion to determine whether the 3D printer is capable of printing directly on the defect. For example, the processor may determine that the 3D printer is unable to fix a crack in a bearing by directly printing on it since the resulting bearing is unlikely to be smooth. Accordingly, if the defective component is a bearing, the processor may determine that directly printing on the defect is not possible.

At operation 256, the processor determines whether the 3D printer is able to print a replacement component. The process may consider, for example, whether the defect has made the 3D printer inoperable, the shape of the defective component, the material of the defective component, and the materials that the 3D printer can use when making this determination.

At decision block 258, the processor determines whether self-repair is possible. This determination may take into consideration the results of operations 252-256. The processor may also determine which type of self-repair is possible (e.g., direct printing or replacement component printing). If self-repair is possible (Yes at decision block 258), the processor causes the 3D printer to perform a self-repair operation at operation 260, and the method 250 ends.

However, if self-repair is not possible (No at decision block 258), the processor determines whether assisted repair is possible at decision block 262. In performing this operation, the processor may determine whether there are any nearby 3D printers that are able to either print a replacement component or directly repair the defective component, as discussed herein. If the processor determines that assisted repair is possible (Yes at decision block 262), the processor requests assisted repair from another 3D printer at operation 264, and the method 250 ends.

Otherwise (No at decision block 262), the processor may alert an operator of the defective component at operation 266, and the method 250 may end. Alerting the operator may include raising an alert or alarm, sending a message to a computer system, or otherwise alerting a human operator of the defect. In some embodiments, the processor may also order a replacement component, if necessary, when alerting the operator. This may reduce the amount of time required to have the defective component replaced by getting the replacement component ordered as soon as the defect is identified.

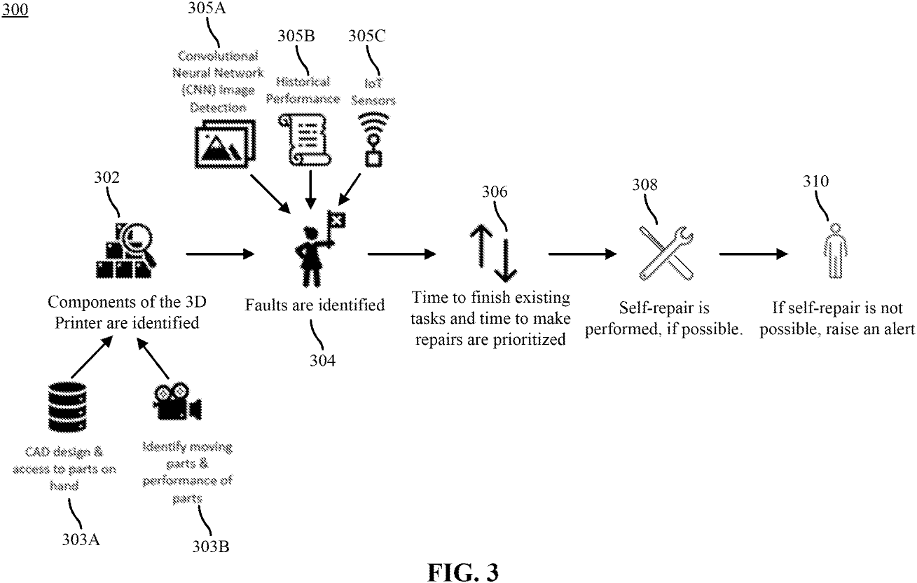

Referring now to FIG. 3, illustrated is an example flow diagram 300 for repairing a defective component in a 3D printer, in accordance with embodiments of the present disclosure. The flow diagram includes four or five main steps, depending on whether self-repair is possible: (i) identifying components of the 3D printer at operation 302, (ii) identifying faults in a component of the 3D printer at operation 304, (iii) re-prioritizing tasks according to time to completion at operation 306, (iv) perform self-repair (if possible) at operation 308, and (v) raise an alert (if self-repair is not possible) at operation 310. Each of these steps may include suboperations, as discussed below.

At operation 302, a 3D printer identifies various components of the 3-D printer. Different components of the 3D printer can be identified uniquely, and the 3D printer may also collect sensor-based information tracking or ultrasound scanning mechanisms. The sensor-based information can provide information such as whether the component is dynamic or static, as well as information such as the speed of the component. The components of the 3D printer can be identified using the CAD design 303A of the 3D printer, assuming that it is available. Additionally, the 3D printer can identify its components using data from one or more cameras 303B.

Each component of the 3D printer may be identified based on static structure or moving machine parts. At the same time, the moving components will be identified based on types of movement, like rotational motion, linear motion, etc. For dynamic, or moving, components, the speed of movement of the component can be identified. Different operational parameters of the 3D printer can also be determined.

Furthermore, in some embodiments, if there is a system that identifies which components are currently on hand, then that system may be integrated with the 3D printer repair system. For example, an inventory control system may be integrated with the 3D printer repair system. This may help identify the various components of the 3D printer, as well as provide helpful information should repairs be necessary.

At operation 304, while printing is being performed, the 3D printing repair system will be identifying if any defect is detected in any of the components. This monitoring and detection may be done using one or more IoT sensors 305C and a fault detection model. The fault detection model may be, for example, a convolutional neural network (CNN) model 305A that relies on image detection techniques for identifying faults. The 3D printer may include a fault detection model for each of a plurality of components. The fault detection models may include, for example, a crack detection model used to detect cracks in components and a speed detection model used to validate speed and performance information for the 3D printer.

The criticality of the defect may be identified based on historical performance degradation information 305B and complete down time information. The defect pattern, performance degradation, time to complete downtime, etc. may be identified using the historical performance information 305B.

Using the information collected from the image analysis, historical data analysis, and sensor analysis, the 3D printer can predict the time to failure for the 3D printer. Expert feedback can also be used to either detect the defect of predict the time to failure for the defective component.

At operation 306, the 3D printer identifies the priority of the activity and predicts the time required to complete the activity. The 3D printer may also predict the time required to rectify the problem. The 3D printer then compares the available time to rectify its own defect and available time before complete downtime. The performance degradation caused by the detected defect can also be determined. Using this information, the 3D printer can identify the comparative priority between the self-repair activity and continuing to perform the current activity (i.e., continue printing current object).

At operation 308, the 3D printer can self-repair itself if it is nimble enough, or another 3D printer can be placed adjacent to it for any repairing (referred to herein as assisted repairing). In order to determine which repair action to perform, the 3D printer analyzes the defect and the type of component to be repaired, like static vs. dynamic. If the defective component is a static component, then stopping of the 3D printer is not required. In this case, the 3D printer can continue to correct the defect while in running condition. If the defective component is a dynamic component, then the proposed 3D printer reduces the rotation speed of the defective component so that once the material is deposited, it does not spread out because of centrifugal force.

For self-repair, the 3D printer will be stopping the 3D printing device in the exact place where the defect is detected. When the machine is stopped, then the nozzle of the 3D printer receives the material with an air pump to deposit the material on the defect. If a replacement component is made instead, either by the 3D printer or an adjacent printer, then the 3D printer or the adjacent 3D printer can print the necessary part to fix the first 3D printer. It can then pass the necessary part to repair it via the air pump.

If the 3D printer is unable to self-repair or perform an assisted repair, then an alert is sent to the user to fix or aid in the fixing at operation 310. In some embodiments, the 3D printer may also order a replacement component if the inventory control system indicates that there is no replacement component on-hand.

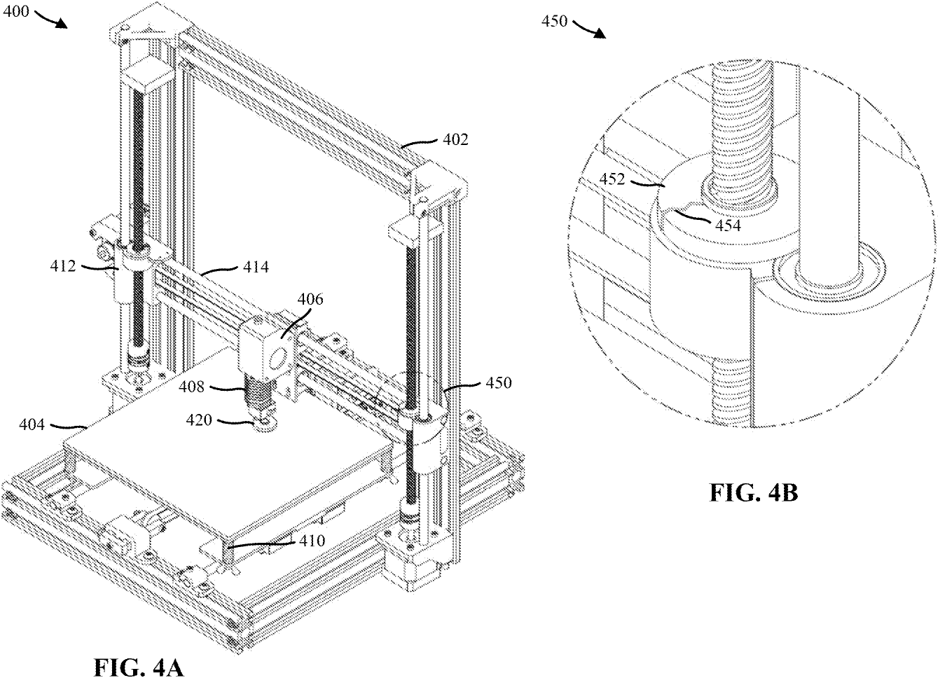

Referring now to FIGS. 4A-4B, illustrated is an example 3D printer 400 during performance of a self-repair operation, in accordance with embodiments of the present disclosure. In particular, FIG. 4A shows a 3D printer 400 printing a replacement component.

The 3D printer 400 comprises a frame 402, a print bed 404, a hotend assembly 406, a nozzle 408, print bed balancing screws 410, y-axis control motors 412, and an extruder 414. The 3D printer 400 may also comprise a camera for monitoring components of the 3D printer and a computer system for controlling the print jobs and for repairing the 3D printer (not shown).

These components may perform functions that are known to persons of ordinary skill in the arts. For example, the frame 402 may provide structural support to the hotend assembly 406 and provide vertical guides for the y-axis control motors 412 and horizontal guides for the z-axis control motors (not labeled). The print bed 404 may provide a flat surface on which the 3D printer 400 prints objects. The hotend assembly 406 may include the x-axis control motors as well as heating elements for melting the material. The hotend assembly 406 may also include a pressure chamber for forcing the melted material out of the nozzle 408. The print bed balancing screws 410 are adjustable screws on all four corners of the print bed 404, and they may be used to adjust the balance of the print bed 404. The y-axis control motors 412 may be used to lift and lower the nozzle 408 during printing. Finally, the extruder 414 may provide a conduit through which the 3D printing filaments are fed from a spool (not shown) to the hotend assembly 406 for depositing onto the print bed 404.

Additionally, the 3D printer 400 may be configured to take an image or other sensor readings of areas of the 3D printer, analyze the data to detect defects in components, and perform a self-repair operation. For example, the 3D printer 400 may detect that there is a defect in a particular region 450 of the 3D printer 400. The 3D printer 400 may then take a picture of the region 450, as shown in FIG. 4B. Through analysis of the captured image, the 3D printer may detect a defect 454, in this case a crack, in a defective component 452.

The 3D printer 400 may then determine that it is unable to repair the defective component 452. This is because the 3D printer 400 lacks the range of motion required to print directly on the defect 454. Accordingly, the 3D printer 400 may instead print a replacement part 420, as shown in FIG. 4A.

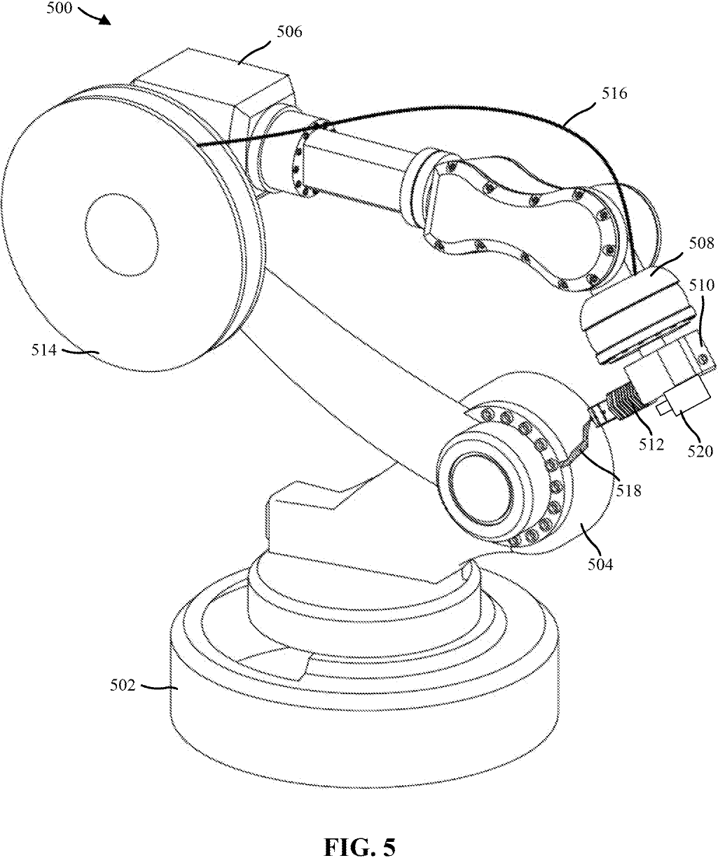

Referring now to FIG. 5, illustrated is a second example 3D printer 500 during performance of a self-repair operation, in accordance with embodiments of the present disclosure. The second example 3D printer 500 is an arm-style 3D printer having a base 502 (which may include a computer system for controlling the 3D printer 500), a shoulder joint 504, an elbow joint 506, a wrist joint 508, a hotend assembly 510, a nozzle 512, a spool 514 of printing filament 516, and a camera 520. The shoulder joint 504, elbow joint 506, and wrist joint 508 may provide a large range of motion and allow the 3D printer 500 to print material in more locations that the 3D printer 400 shown in FIGS. 4A-4B. The hotend assembly 510 and nozzle 512 may operate substantially similar to the hotend assembly 406 and nozzle 408 discussed in reference to FIGS. 4A-4B.

The spool 514 may store and feed filament 516 to the hotend assembly 510 for melting and printing out of the nozzle 512. The camera 520 may allow the 3D printer 500 to take images of its various components, as well as assist the 3D printer 500 in printing exactly where it wants to.

As shown in FIG. 5, thanks to its higher mobility when compared to the 3D printer 400, the 3D printer 500 is capable of performing a self-repair operation that involves printing directly on the crack 518. In particular, as shown in FIG. 5, the 3D printer 500 can detect the crack 518 using the camera 520 and then fill in the crack by printing directly to it.

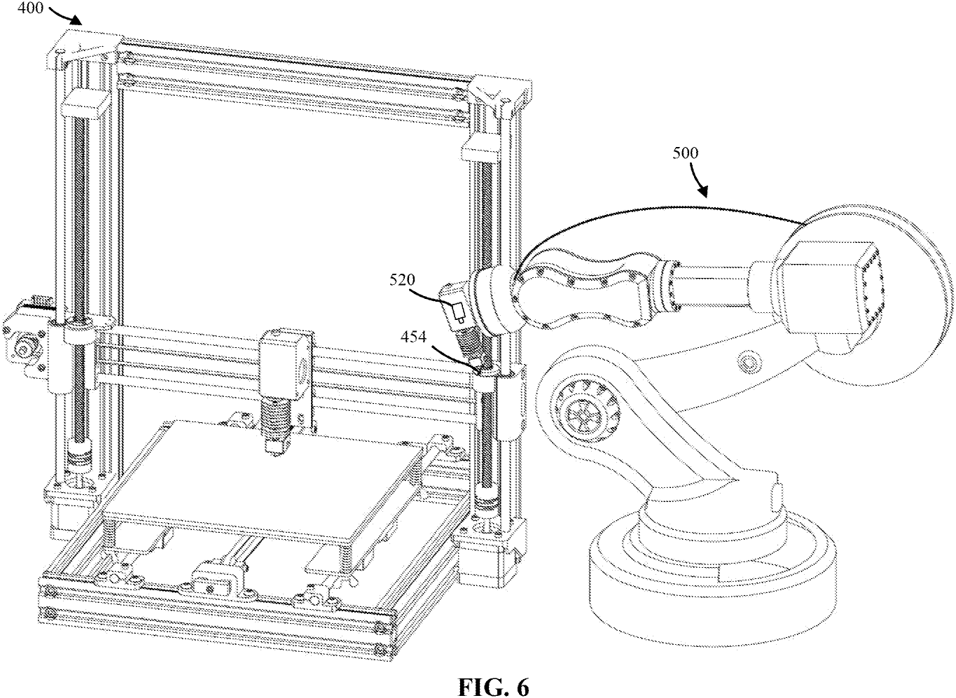

Referring now to FIG. 6, illustrated is a first example 3D printer 500 performing an assisted repair operation to repair a second 3D printer 400, in accordance with embodiments of the present disclosure. In FIG. 6, the first 3D printer 500 may be the same 3D printer as shown in FIG. 5, and the second 3D printer 400 may be the same 3D printer as shown in FIG. 4A.

In particular, as shown in FIG. 6, the first 3D printer 500 is directly printing on the defect 454 of the second 3D printer 400. The first 3D printer 500 is utilizing its camera 520 to ensure that it is laying material directly on and in the defect 454. Because the defect 454 is located on a component that moves during printing, the second 3D printer 400 may have to halt printing during the assisted repair. However, the second 3D printer 400 may be able to start printing again as soon as the defect 454 is filled, without having to wait for solidification, due to the fact that the defective component is not a fast moving or rotational component.

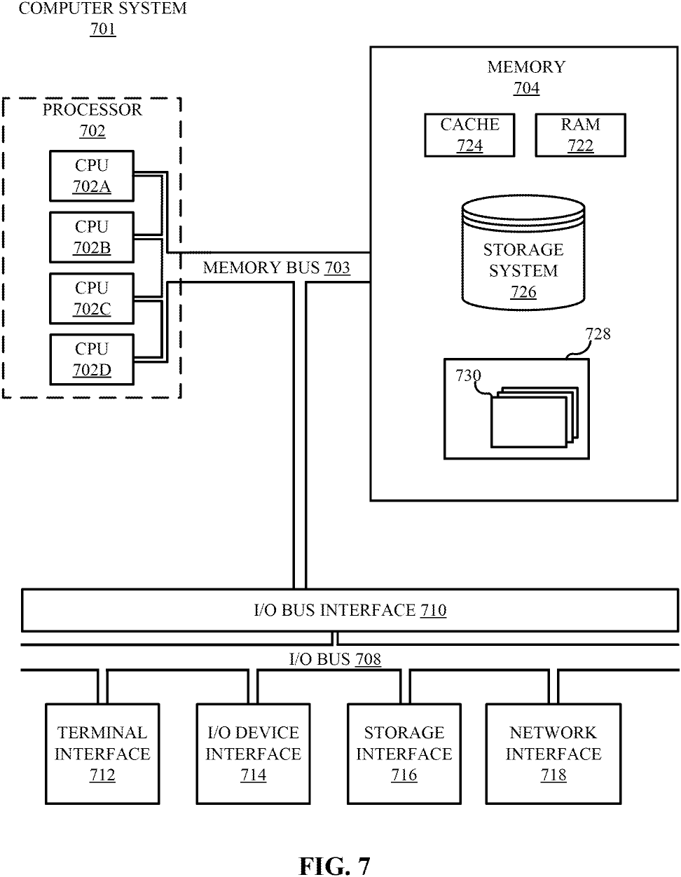

Referring now to FIG. 7, shown is a high-level block diagram of an example computer system 701 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 701 may comprise one or more CPUs 702, a memory subsystem 704, a terminal interface 712, a storage interface 716, an I/O (Input/Output) device interface 714, and a network interface 718, all of which may be communicatively coupled, directly or indirectly, for inter-component communication via a memory bus 703, an I/O bus 708, and an I/O bus interface unit 710.

The computer system 701 may contain one or more general-purpose programmable central processing units (CPUs) 702A, 702B, 702C, and 702D, herein generically referred to as the CPU 702. In some embodiments, the computer system 701 may contain multiple processors typical of a relatively large system; however, in other embodiments the computer system 701 may alternatively be a single CPU system. Each CPU 702 may execute instructions stored in the memory subsystem 704 and may include one or more levels of on-board cache.

System memory 704 may include computer system readable media in the form of volatile memory, such as random access memory (RAM) 722 or cache memory 724. Computer system 701 may further include other removable/non-removable, volatile/non-volatile computer system storage media. By way of example only, storage system 726 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 704 can include flash memory, e.g., a flash memory stick drive or a flash drive. Memory devices can be connected to memory bus 703 by one or more data media interfaces. The memory 704 may include at least one program product having a set (e.g., at least one) of program modules that are configured to carry out the functions of various embodiments.

One or more programs/utilities 728, each having at least one set of program modules 730 may be stored in memory 704. The programs/utilities 728 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Program modules 730 generally perform the functions or methodologies of various embodiments.

Although the memory bus 703 is shown in FIG. 7 as a single bus structure providing a direct communication path among the CPUs 702, the memory subsystem 704, and the I/O bus interface 710, the memory bus 703 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 710 and the I/O bus 708 are shown as single respective units, the computer system 701 may, in some embodiments, contain multiple I/O bus interface units 710, multiple I/O buses 708, or both. Further, while multiple I/O interface units are shown, which separate the I/O bus 708 from various communications paths running to the various I/O devices, in other embodiments some or all of the I/O devices may be connected directly to one or more system I/O buses.

In some embodiments, the computer system 701 may be a multi-user mainframe computer system, a single-user system, or a server computer or similar device that has little or no direct user interface, but receives requests from other computer systems (clients). Further, in some embodiments, the computer system 701 may be implemented as a desktop computer, portable computer, laptop or notebook computer, tablet computer, pocket computer, telephone, smart phone, network switches or routers, or any other appropriate type of electronic device.

It is noted that FIG. 7 is intended to depict the representative major components of an exemplary computer system 701. In some embodiments, however, individual components may have greater or lesser complexity than as represented in FIG. 7, components other than or in addition to those shown in FIG. 7 may be present, and the number, type, and configuration of such components may vary. Furthermore, the modules are listed and described illustratively according to an embodiment and are not meant to indicate necessity of a particular module or exclusivity of other potential modules (or functions/purposes as applied to a specific module).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

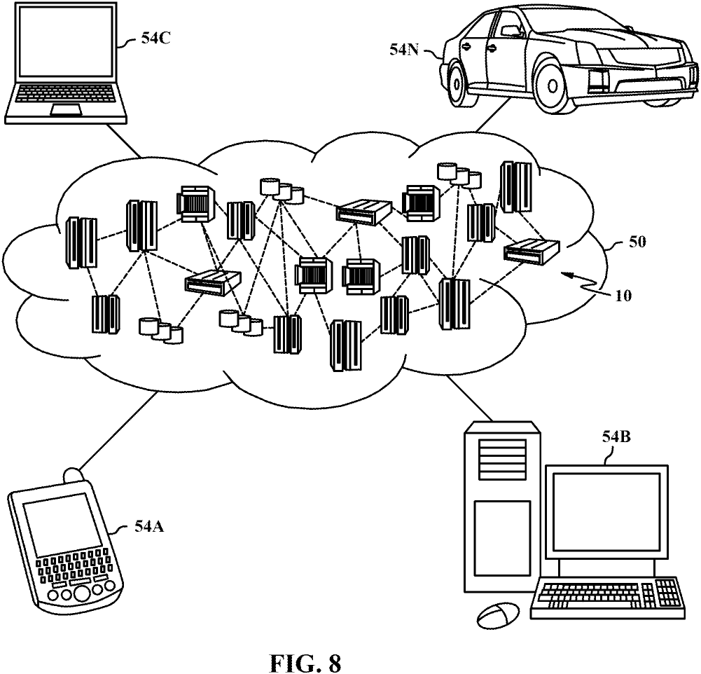

Referring now to FIG. 8, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

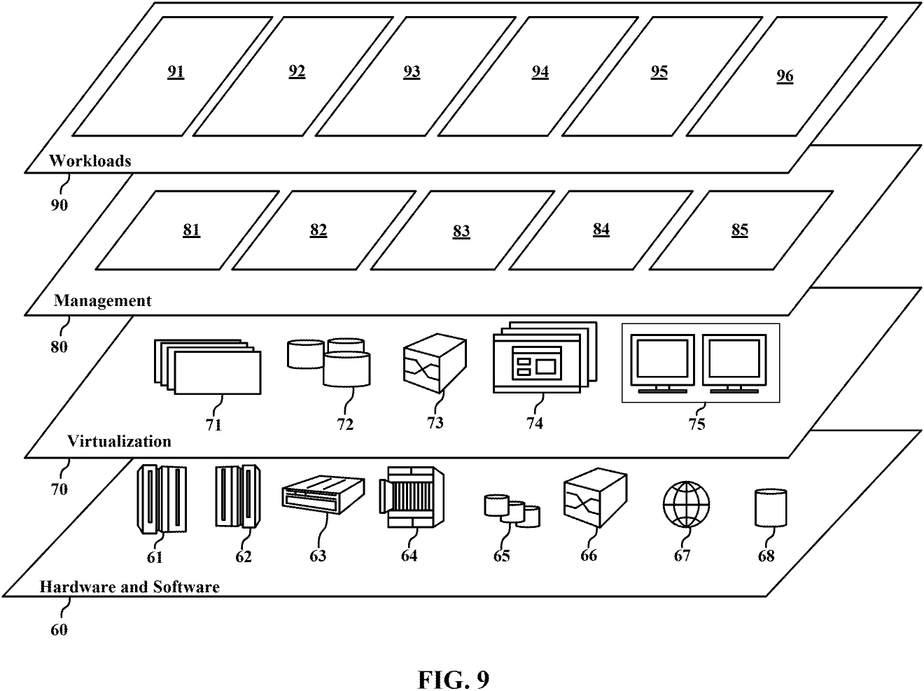

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and 3D printer repair 96. The 3D printer repair 96 may include instructions for performing various functions disclosed herein, such as performing a self-repair or assisted repair operation on a defective component.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

As used herein, “a number of” when used with reference to items, means one or more items. For example, “a number of different types of networks” is one or more different types of networks.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications, alterations, and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s). Additionally, it is intended that the following claim(s) be interpreted as covering all such alterations and modifications as fall within the true spirit and scope of the invention.

What is claimed is:

1. A method comprising:
identifying a defective component in a 3D printer;
determining one or more repair actions for the defective component;
determining an order of priority for a set of print jobs for the 3D printer and the one or more repair actions; and
performing the set of print jobs and the one or more repair actions in accordance with the determined order of priority.

2. The method of claim 1, wherein the one or more repair actions comprise:
printing, by the 3D printer, a replacement component for the defective component; and
replacing the defective component with the replacement component.

3. The method of claim 1, wherein the one or more repair actions comprise:
repairing, by the 3D printer, the defective component by directly printing on the defect.

4. The method of claim 1, wherein the one or more repair actions comprise:
requesting a second 3D printer to repair the defective component by directly printing on the defect.

5. The method of claim 4, wherein the method further comprises:
continuing, by the 3D printer, performing the set of print jobs while the second 3D printer is repairing the defective component.

6. The method of claim 1, wherein identifying the defective component in the 3D printer comprises:
detecting, from one or more sensors, sensor data;
comparing the sensor data to historical sensor data;
determining, based on the comparing, that there is a defect in a region of the 3D printer, the region including the defective component;
capturing an image of the region of the 3D printer; and
analyzing the captured image using image analysis to detect a defect in the defective component.

7. The method of claim 1, wherein determining the order of priority for the set of print jobs for the 3D printer and the one or more repair actions comprises:
predicting a time-to-failure for the defective component;
predicting an amount of time required to perform each print job of the set of print jobs;
predicting an amount of time required to perform the one or more repair actions;
grouping the set of print jobs into a first subset of print jobs and a second subset of print jobs, wherein a total amount of time required to perform the first subset of print jobs plus the amount of time required to perform the one or more repair actions is less than the predicted time-to-failure for the defective component; and
in response to determining the total amount of time is less than the predicted time-to-failure:
prioritizing the first subset of print jobs such that they are performed prior to the one or more repair actions; and
prioritizing the second subset of print jobs such that they are performed after the one or more repair actions.

8. A 3D printer comprising:
a plurality of components;
a memory; and
a processor communicatively coupled to the memory, wherein the processor is configured to perform a method comprising:
identifying a defective component in the 3D printer;
determining one or more repair actions for the defective component;
determining an order of priority for a set of print jobs for the 3D printer and the one or more repair actions; and
performing the set of print jobs and the one or more repair actions in accordance with the determined order of priority.

9. The 3D printer of claim 8, wherein the one or more repair actions comprise:
printing, by the 3D printer, a replacement component for the defective component; and
replacing the defective component with the replacement component.

10. The 3D printer of claim 8, wherein the one or more repair actions comprise:
repairing, by the 3D printer, the defective component by directly printing on the defect.

11. The 3D printer of claim 8, wherein the one or more repair actions comprise:
requesting a second 3D printer to repair the defective component by directly printing on the defect.

12. The 3D printer of claim 11, wherein the method further comprises:
continuing, by the 3D printer, performing the set of print jobs while the second 3D printer is repairing the defective component.

13. The 3D printer of claim 8, wherein identifying the defective component in the 3D printer comprises:
detecting, from one or more sensors, sensor data;
comparing the sensor data to historical sensor data;
determining, based on the comparing, that there is a defect in a region of the 3D printer, the region including the defective component;
capturing an image of the region of the 3D printer; and
analyzing the captured image using image analysis to detect a defect in the defective component.

14. The 3D printer of claim 8, wherein determining the order of priority for the set of print jobs for the 3D printer and the one or more repair actions comprises:
predicting a time-to-failure for the defective component;
predicting an amount of time required to perform each print job of the set of print jobs;
predicting an amount of time required to perform the one or more repair actions;
grouping the set of print jobs into a first subset of print jobs and a second subset of print jobs, wherein a total amount of time required to perform the first subset of print jobs plus the amount of time required to perform the one or more repair actions is less than the predicted time-to-failure for the defective component; and
in response to determining the total amount of time is less than the predicted time-to-failure:
prioritizing the first subset of print jobs such that they are performed prior to the one or more repair actions; and
prioritizing the second subset of print jobs such that they are performed after the one or more repair actions.

15. A computer program product comprising a computer readable storage medium having program instructions embodied therewith, the program instructions executable by a computer to perform a method comprising:
identifying a defective component in a 3D printer;
determining one or more repair actions for the defective component;
determining an order of priority for a set of print jobs for the 3D printer and the one or more repair actions; and
performing the set of print jobs and the one or more repair actions in accordance with the determined order of priority.

16. The computer program product of claim 15, wherein the one or more repair actions comprise:
repairing, by the 3D printer, the defective component by directly printing on the defect.

17. The computer program product of claim 15, wherein the one or more repair actions comprise:
requesting a second 3D printer to repair the defective component by directly printing on the defect.

18. The computer program product of claim 17, wherein the method further comprises:
continuing, by the 3D printer, performing the set of print jobs while the second 3D printer is repairing the defective component.

19. The computer program product of claim 15, wherein identifying the defective component in the 3D printer comprises:
detecting, from one or more sensors, sensor data;
comparing the sensor data to historical sensor data;
determining, based on the comparing, that there is a defect in a region of the 3D printer, the region including the defective component;
capturing an image of the region of the 3D printer; and
analyzing the captured image using image analysis to detect a defect in the defective component.

20. The computer program product of claim 15, wherein determining the order of priority for the set of print jobs for the 3D printer and the one or more repair actions comprises:
predicting a time-to-failure for the defective component;
predicting an amount of time required to perform each print job of the set of print jobs;
predicting an amount of time required to perform the one or more repair actions;
grouping the set of print jobs into a first subset of print jobs and a second subset of print jobs, wherein a total amount of time required to perform the first subset of print jobs plus the amount of time required to perform the one or more repair actions is less than the predicted time-to-failure for the defective component; and
in response to determining the total amount of time is less than the predicted time-to-failure:
prioritizing the first subset of print jobs such that they are performed prior to the one or more repair actions; and
prioritizing the second subset of print jobs such that they are performed after the one or more repair actions.
